(19) United States
(12) Patent Application Publication
(10) Pub. No.: US 2012/0307210 A1
(43) Pub. Date: Dec. 6, 2012

(54) STEREOSCOPIC DISPLAY APPARATUS AND METHOD

(76) Inventor: Riney Bennett, Los Alamos, NM (US)

(21) Appl. No.: 13/017,996

(22) Filed: Jan. 31, 2011

Related U.S. Application Data
(60) Provisional application No. 61/300,144, filed on Feb. 1, 2010.

(51) Int. Cl. G02B 27/24; G02B 27/22

(52) U.S. Cl. 353/7; 353/121

(57) ABSTRACT

The present invention comprises an apparatus and method for presenting a three-dimensional image in a stereoscopic environment. The apparatus includes glasses, and a projector having two or more light sources, one or more mirrors, and an adjustment device.

### CROSS-REFERENCE TO RELATED APPLICATIONS

This application claims priority to and the benefit of the filing of U.S. Provisional Patent Application Ser. No. 61/300,144, entitled “Stereoscopic Display Apparatus and Method”, filed on Feb. 1, 2010, and the specification thereof is incorporated herein by reference.

### BACKGROUND OF THE INVENTION

1. Field of the Invention (Technical Field)

Embodiments of the present invention relate to an apparatus configured to present a three-dimensional (3D) image in a stereoscopic environment. When viewed through polarized or active-shutter 3D glasses, the intersection of a plurality of beams of light synchronized with the glasses appear as a point of light floating in space. Embodiments of the present invention preferably use a pivotable light source or a mirror to project a plurality of points of light into 3D images when viewed through 3D glasses with or without the use of a screen or other projection surface.

2. Description of Related Art

For the human eye, due to the independent visual system for the right eye and the left eye, an image captured by the right eye is different from the one captured by the left eye. Therefore, humans can merge these individual images (parallax images) together and obtain a vision with depth perception. A key to 3D displays is a mechanism to present the left and right images to the corresponding eyes without crosstalk.

Stereoscopic or 3D imaging systems have been employed to give a three-dimensional appearance to field sequential images displayed on a display screen. One form of three-dimensional appearance is created by active 3D glasses that switch between opaque and transmissive optical states to alternately transmit to a viewer left- and right-eye views of a stereoscopic image that is sequentially displayed on the screen. A viewer fuses the separate left- and right-eye images into a single stereoscopic image. A maximum contrast ratio can be achieved by providing maximum output light extinction in the opaque state to block an image to the viewer's eye and maximum light transmission in the transmissive state to convey an image to the viewer's eyes.

A field-sequential stereoscopic display outputs a right image and a left image sequentially, and the left eye and the right eye of the stereoscope are shut synchronized with the right image and the left image. If the switching between left and right eyes is fast enough that human eyes cannot distinguish the change of switching, then the appearance of stereo is generated. In addition, for generating ideal feeling of stereoscopy, the switching between left and right eyes of the stereoscope should be synchronized with the left image and right image on the screen.

A shutter type of liquid crystal shutter glasses (hereinafter referred to as shutter glasses) is useful, but not required for 3D stereo viewing. The shutter glasses do not shutter the left eye and right eye by any mechanical shuttering, but shutter by alternately electrically activating an electronic shuttering. One form of glasses has high-speed electronic shutters that open and close in sync with the images on the display. Liquid crystals are preferably used for the shutters because an electronic signal can make the crystal turn instantly from transparent to opaque.

For presentations, a presenter sometimes uses a laser pointer to point to a presentation item. The conventional laser pointer includes a low power laser that allows the user to shine a concentrated light beam on a specific spot on a presentation item of interest. The conventional portable laser pointer is most commonly used to project a point of light to highlight items of interest during a presentation. A presenter in a 3D visualization facility will often point out features of interest with a conventional laser pointer, but the conventional laser pointer makes a single spot on the display surface, and audience members find it difficult to recognize the object of interest to the presenter.

Accordingly, it would be highly desirable to provide an improved presentation device that acts upon a synchronized signal as do shuttering glasses, and displays two time-sliced beams that are synchronized with each image of the stereo-pair being displayed. The presentation device can also have a controller allowing a user to interactively vary the divergence of the two beams in order to fine-tune the separation of two spots where the beams hit the display surface so that the 3D point appears with proper separation (parallax) and appears (to the presenter and members of the audience) to be on the object of interest.

In another method of generating stereo images, two images are created superimposed onto the same screen through circular polarizing filters of opposite handedness. The viewer wears another form of eyeglasses (sometimes called passive glasses), which contain a pair of analyzing filters (circular polarizers mounted in reverse) of opposite handedness. Light that is left-circularly polarized is blocked by the right-handed analyzer, while right-circularly polarized light is extinguished by the left-handed analyzer. The result when viewed through the glasses is a stereoscopic image.

Accordingly, it would be highly desirable to provide an improved presentation device that provides two circularly polarized beams of opposite handedness. The presentation device can also have a controller allowing a user to interactively vary the divergence of the two beams in order to fine-tune the separation of two spots where the beams hit the display surface so that the 3D point appears with proper separation (parallax) and appears (to the presenter and members of the audience) to be on the object of interest.

### BRIEF SUMMARY OF EMBODIMENTS OF THE PRESENT INVENTION

One embodiment of the present invention comprises an apparatus for presenting a three-dimensional (3D) image. This embodiment comprises a pair of glasses worn by a user and a projector having a power source and two or more light sources, wherein at least one of the two or more light sources is pivotable, wherein the projector does not comprise one or more optical shutters, and wherein the apparatus presents a 3D image that appears to the user to float in space. The apparatus optionally comprises one or more mirrors for guiding said two or more light sources. The one or more mirrors can be rotatable and have an adjustment device for adjusting the one or more mirrors. The apparatus of this embodiment preferably does not comprise a drive module. The glasses can be shutter glasses or passive glasses. If a user has shutter glasses, the two or more light sources are preferably synchronized with the glasses. An electrical circuit can be used for synchronization. The two or more light sources can be fixed and/or pivotable and/or co-planar. The projector can comprise a laser pointer.

Another embodiment of the present invention comprises a method for presenting a three-dimensional (3D) image. The method preferably includes providing a pair of glasses worn by a user, powering a projector, the projector comprising a power source and two or more light sources, wherein said projector does not comprise one or more optical shutter, emitting the two or more light sources from separate points, adjusting the two or more light sources to intersect at a point, and displaying a 3D image that appears to the user to float in space. The method can further comprise guiding two or more light sources using one or more mirrors and adjusting the one or more mirrors via an adjustment device. The projector preferably does not comprise a drive module. The glasses preferably comprise shutter glasses or passive glasses. The method preferably comprises synchronizing the two or more light sources with shutter glasses via an electrical circuit.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 illustrates an embodiment of the present invention comprising an apparatus for creating a floating point of light having two mirrors.

FIG. 2 illustrates an embodiment of the present invention comprising an apparatus for creating a floating point of light having one mirror.

FIG. 3 illustrates an embodiment of the present invention comprising an apparatus for creating a floating point of light having no mirrors and one pivoting light source.

FIG. 4 illustrates another embodiment of the present invention comprising an apparatus for creating a three-dimensional image floating in space.

FIG. 5 illustrates yet another embodiment of the present invention comprising colored three-dimensional images.

FIG. 6 illustrates one embodiment of the present invention comprising a hand-held projector that creates a floating image of a design drawn on a touch-screen when viewed through shutter glasses.

FIG. 7 illustrates an embodiment of the present invention comprising inserting circular polarizers of opposite polarity.

FIG. 8 illustrates an embodiment of the present invention comprising an apparatus and method of determining the location of an image projected by a projector.

### DETAILED DESCRIPTION OF THE INVENTION

As used throughout this specification and claims, “glasses” includes, but is not limited to, active-shutter glasses, circularly polarized three-dimensional glasses, three-dimensional glasses, combinations thereof and the like.

As used throughout this specification and claims, “projector” means a device for projecting a beam of light. A projector includes, but is not limited to, a hand-held projector, a pointer, a laser pointer, a large screen, combinations thereof and the like.

As used throughout this specification and claims, “light source” is defined as any device that can emit light beams, such as, but not limited to a laser, LEDs, other highly collimated light sources such as search lights, combinations thereof and the like.

As used throughout this specification and claims, “adjustment device” is defined as any device that can adjust one or more mirrors, such as, but not limited to, a mechanical linkage, electric motor, galvanometer, micro-electrical-mechanical system (MEMS) micro-mirror, combinations thereof and the like.

As used throughout this specification and claims, space is defined as a three-dimensional region in a room or outside.

Embodiments of the present invention comprise an apparatus and method of creating one, two, and three-dimensional figures floating in space when viewed through glasses.

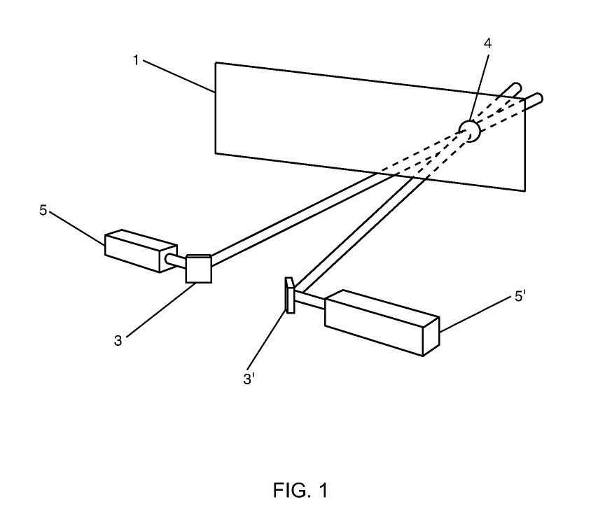

Referring to FIGS. 1 (an embodiment showing two mirrors) and 2 (an embodiment showing one mirror), one embodiment of the present invention comprises glasses 1 and a projector (not shown) comprising a power source (also not shown), such as but not limited to batteries, one or more light sources 5 and/or 5′ whose beams are optionally guided by one or two mirrors 3 and/or 3′ to create floating point of light 4. At least one light source is preferably fixed and a second light source is preferably pivotable. One light source preferably points to one of the mirrors 3, which is rotatable. An axis of rotation of mirror 3 preferably passes through an axis of one or more of the beams of light sources 5. The axis of rotation of mirror 3 is also preferably perpendicular to the plane of light sources 5 and 5′. A user can preferably adjust the rotational angle of mirror 3. The beams from light sources 5 and 5′ preferably reflect off mirror 3 to a point that a user can choose by adjusting the rotation of mirror 3. The rotational angle of mirror 3 can be adjusted by an adjustment device. A preferable adjustment device is a micro-mirror. A micro-mirror is a small mirror built onto a semiconductor chip. The orientation of the MEMS micro-mirror is preferably controlled by electrical signals.

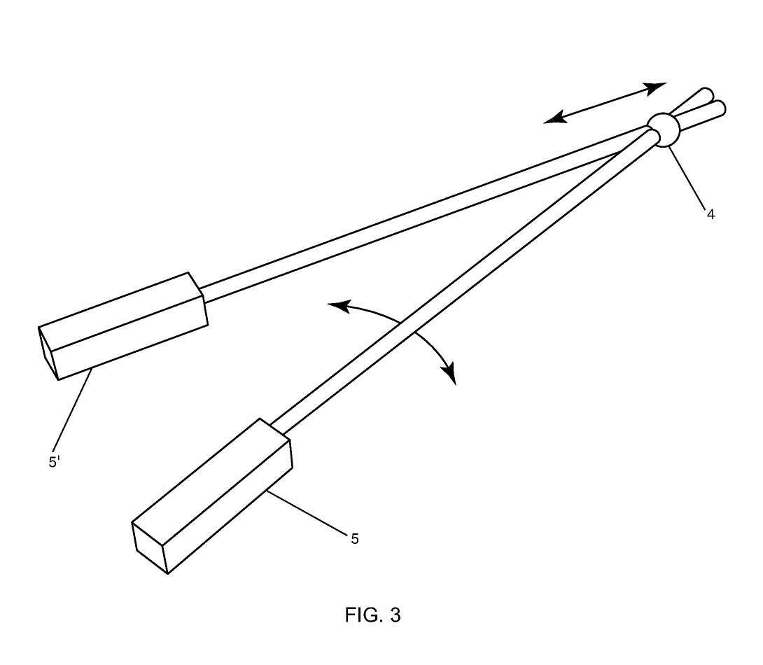

Referring to FIG. 3, in an alternative embodiment of the present invention, no mirrors are used and one light source is fixed and another light source is allowed to pivot. However, both light sources can be allowed to pivot. Light sources are preferably constructed such that at least two light sources are co-planar. A pivotable light source can be rotated to adjust the divergence of light sources 5 and 5′.

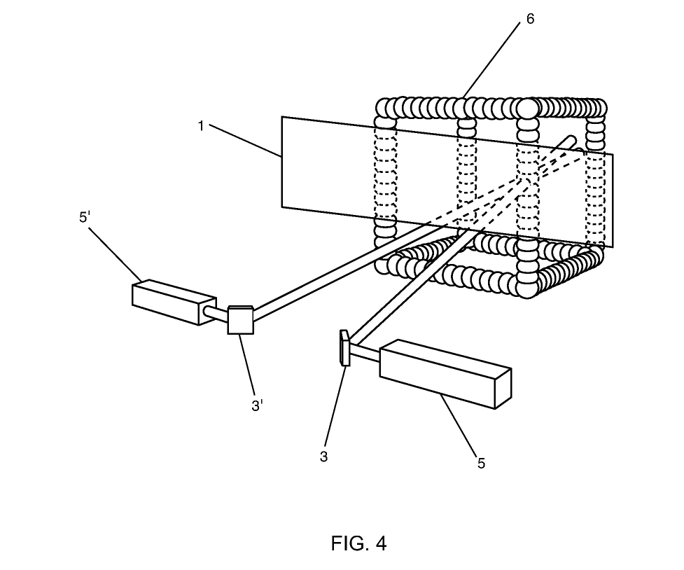

Referring to FIG. 4, in another embodiment of the present invention, each light source is individually directed by a separate mirror. Each mirror can preferably rotate on at least two orthogonal axes. Using this arrangement, the location of the intersection of the light sources can be manipulated in three dimensions. Those skilled in the art understand that the reflective effect of one mirror rotating on two orthogonal axes can be duplicated by the combination of two mirrors each rotating on a single axis.

The orientations of the mirrors rotated to locate the intersection of the light sources at a particular point relative to the centers of the mirrors can be computed by a microprocessor. This orientation information is preferably sent to the adjustment device, which controls the orientation of the mirrors.

In one embodiment of the present invention, a 3D display apparatus, such as a 3D television or 3D movie, preferably alternately displays right and left eye views. The timing of the alternating views is communicated through a synchronization signal transmitted by the 3D display apparatus. In this embodiment, glasses 1 comprise shutter glasses. Shutter glasses preferably turn the right-eye lens opaque during a left eye view from the 3D display apparatus and the right-eye lens transparent when the 3D display apparatus is showing a right-eye view. Glasses 1 preferably turn the left-eye lens transparent when the left eye view is on the 3D display and the left-eye lens opaque when the right-eye view is on. Light sources 5 and 5′ in a projector are preferably synchronized to turn on and off with glasses 1 to form floating point of light 4, preferably within a 3D display apparatus. Light sources 5 and 5′ preferably turn on and off by an electrical circuit. The synchronization signal may be transmitted from the 3D display apparatus electronically by wire, acoustically, optically or by radio. A receiver in a projector, preferably a 3D laser pointer, receives the synchronization signal from the 3D display system. A micro-processor or electrical circuit preferably decodes the signal. An electrical circuit turns the light sources of the projector on and off in synchronization with the signal from the 3D display system. This enables the right light source to turn on when the right-eye image is shown and the left light source to turn on when the left-eye image is shown.

The apparatus of one embodiment preferably comprises a projector having two beams, one for a right eye and one for a left eye. When viewed through glasses a 3D image is formed where the two beams intersect. Pivoting the light source beams in the projector enables the 3D image to move in and out of depth. Alternatively to using pivoting light sources, mirrors can be used to move the light source beams.

Referring to FIG. 4, by rapidly guiding light sources 5 and 5′ with mirrors 3 and 3′ to intersect in various positions, normal human vision through glasses 1 perceives three-dimensional object 6 floating in space.

In one embodiment of the present invention, a light source beam shines back and forth or scans on a path on the screen a minimum of approximately 10 to 30 times per second. The path of the point of light produced by the beam then appears to be continuous to the human eye. This effect is well-known in images produced in laser shows. By guiding the beam with the adjustment device at such a rate or higher, an image can be produced that is visible to the human eye when wearing glasses. If the scan rate is below the minimum rate for the human eye, the intersection of the light source beams appear as a moving dot. If all the points in the image are parallel to the plane of the 3D display screen, the image appears in two dimensions. If points of the image are not parallel to the plane of the display screen, the images appears in three dimensions.

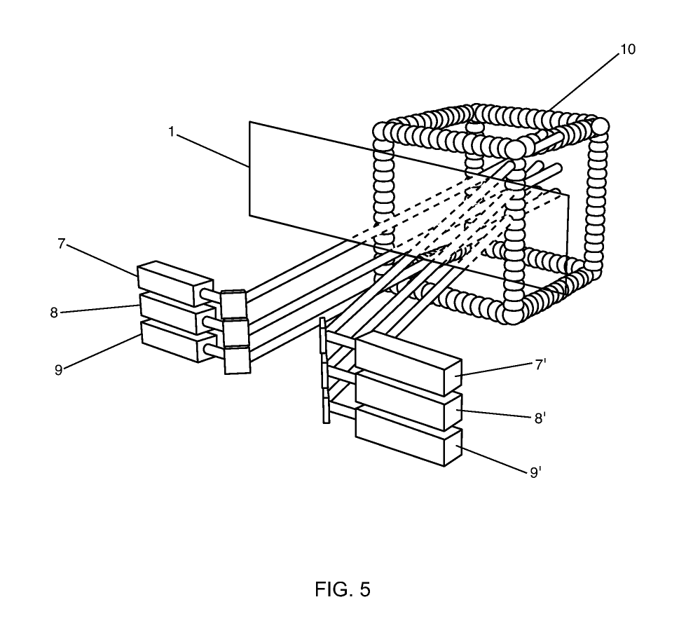

Referring to FIG. 5, by using light sources 7, 7′, 8, 8′, 9 and 9′ of different colors, such as red, blue and green, perceived three-dimensional image 10 can be colored.

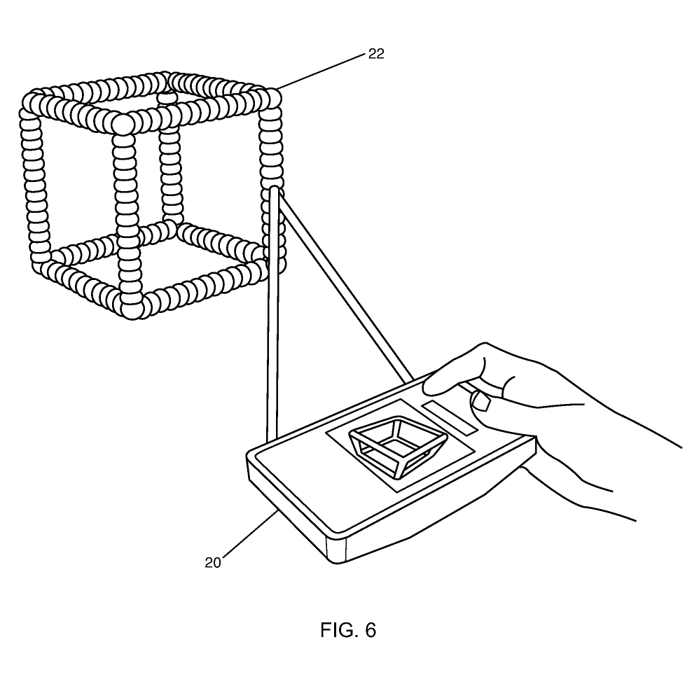

Referring to FIG. 6, one embodiment of the present invention comprises input device 20, such as a touch screen, keypad and/or touchpad incorporated into a projector. Images selected or created on input device 20 are reproduced in space by electronics in communication with an adjustment device. The electronics transmit to the adjustment device where to position the mirrors to create 3D image 22 in space.

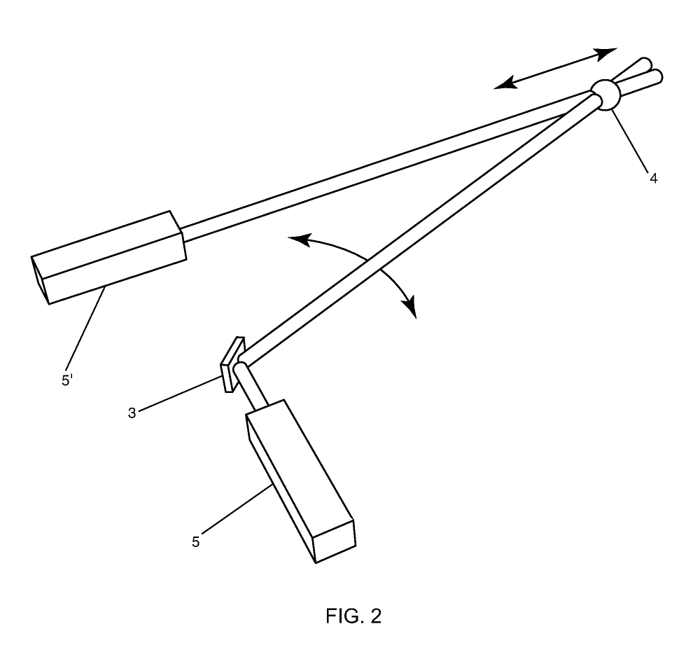

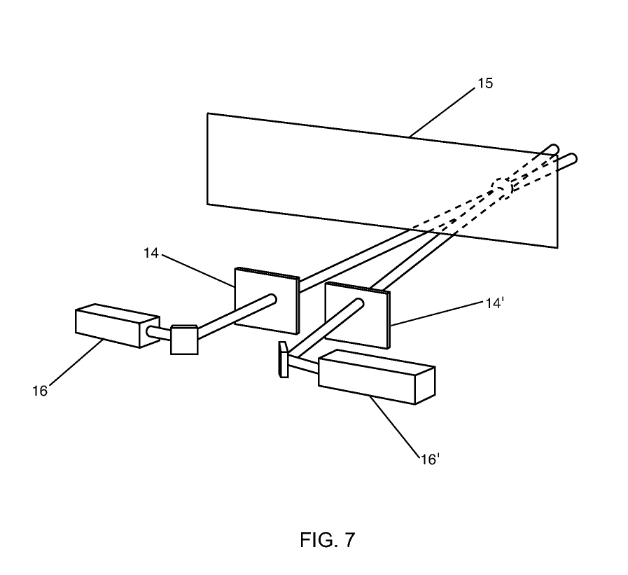

Referring to FIG. 7, by inserting circular polarizers of opposite polarity 14 and 14′, in front of the beams of light sources 16 and 16′, glasses 15, preferably circularly polarized glasses or passive glasses, can be used to create the same effects as the embodiments illustrated in FIGS. 1-6. Passive glasses have no electronics and the light sources stay on continuously and do not have to be turned on and off, like shutter glasses. Users can rotate their heads with passive glasses and still see the 3D effect. Passive glasses do not require synchronization.

In one embodiment of the present invention, a projector creates one, two, and/or three-dimensional figures floating within a 3D display system or in space when viewed through glasses does not require and/or does not have optical shutters or liquid crystal shuttering lenses. Rather, this embodiment of the present invention simply turns the power to light sources on and off instead of using optical shutters to shut the light from the light beams on and off. The light sources are connected to a power source. When the power source is turned on, the light sources emit light. When the power source is turned off, the light sources do not emit light. A 3D display system emits a synchronization signal transmitted electronically by wire, acoustically, optically or by radio. A receiver in a projector receives the synchronization signal. A micro-processor or electrical circuit decodes the signal. An electrical circuit turns the light sources on and off in synchronization with the signal. By this means the right light source is turned on when the right-eye image is shown and the left light source is turned on when the left-eye image is shown. Thus, the same 3D effect is created without the use of optical shutters.

In another embodiment of the present invention, the apparatus does not require and/or does not have a drive module for generating a drive signal.

In an alternative embodiment of the present invention, a display system is not required to create a floating image in space. In a dim environment without reflective walls, (such as a room with very dim lighting and dark non-reflective walls or possibly outside at night) a projector can create a floating image in space.

One embodiment of the present invention comprises a method of presenting a 3D image that appears to float in space. In this embodiment, a user preferably turns on a projector at the power source. The user points the projector at an object of interest in a 3D display, such as a 3D TV or 3D movie. The projector creates a dot that appears to penetrate a screen and can point to a depth. For example, if a user wants to point to an object within a 3D display, the apparatus can create a dot on the object at the same depth as the object. A standard pointer can only create a dot on the screen of the 3D display. The user controls an adjustment device to adjust the deviation of the light beams such that the image generated by the pointer is at the same apparent 3D depth as the object of interest. The user may turn the projector power on and off as desired.

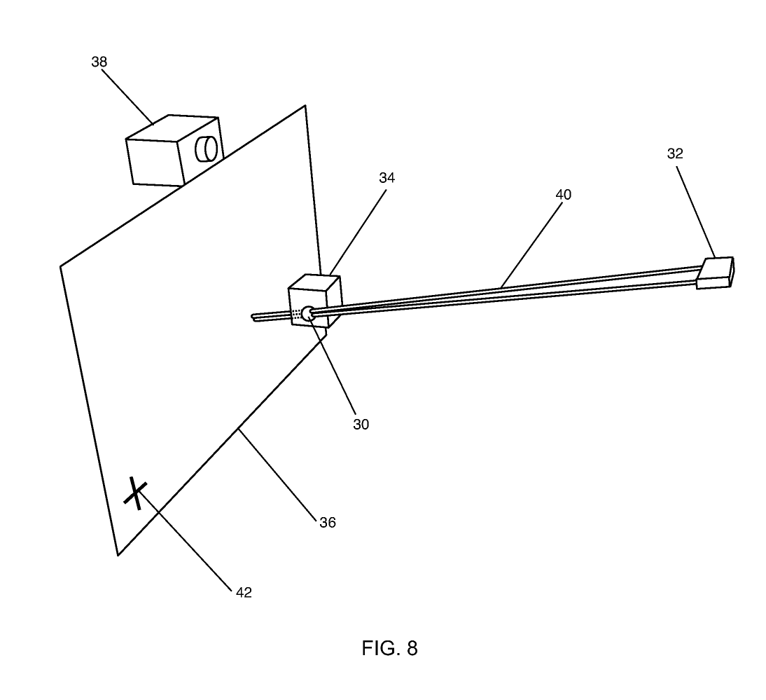

Referring to FIG. 8, in another embodiment of the present invention, it may desirable for the purposes of interactive software or games to know the location of image 30 projected by projector 32 relative to object or point of interest 34 shown in 3D display system 36. Three-dimensional display system 36 preferably comprises camera system 38 which can determine the location in space of projector 32. In one embodiment of the present invention, the divergence angle of light beams 40 is determined through either the control signals sent to the adjustment device or through a rotation sensor (not shown) attached to the adjustment device. The distance from image 30 to projector 32 can thus be calculated. Circuitry (not shown) for sensing the attitude (angular rotation from horizontal) and heading (compass direction) of projector 32 is preferably attached to projector 32. Using the distance information, the location of image 30 relative to projector 32 can be calculated. The information from the rotation, heading and attitude sensors can be transmitted wirelessly from projector 32 to a computer (not shown) controlling 3D display system 36. This information preferably allows the computer to respond to the location of image 30. Target 42 of known location on 3D display system 36 can be used to verify that the sensors are working correctly.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An apparatus for presenting a three-dimensional (3D) image comprising:
a pair of glasses worn by a user; and
a projector comprising a power source and two or more light sources;
wherein at least one of said two or more light sources is pivotable;
wherein said projector does not comprise one or more optical shutters; and
wherein said apparatus presents a 3D image that appears to the user to float in space.

2. The apparatus of claim 1 further comprising one or more mirrors for guiding said two or more light sources.

3. The apparatus of claim 2 further comprising an adjustment device for adjusting said one or more mirrors.

4. The apparatus of claim 2 wherein said one or more mirrors are rotatable.

5. The apparatus of claim 1 wherein said apparatus does not comprise a drive module.

6. The apparatus of claim 1 wherein said glasses comprise shutter glasses.

7. The apparatus of claim 6 wherein said two or more light sources are synchronized with said glasses.

8. The apparatus of claim 7 further comprising an electrical circuit for synchronizing said two or more light sources.

9. The apparatus of claim 1 wherein one of said two or more light sources is fixed.

10. The apparatus of claim 1 wherein one of said two or more light sources is pivotable.

11. The apparatus of claim 1 wherein said two or more light sources are co-planar.

12. The apparatus of claim 1 wherein said projector comprises a laser pointer.

13. The apparatus of claim 1 wherein said glasses comprises passive glasses.

14. A method for presenting a three-dimensional (3D) image comprising:
providing a pair of glasses worn by a user;
powering a projector, the projector comprising a power source and two or more light sources, wherein said projector does not comprise one or more optical shutter;
emitting the two or more light sources from separate points;
adjusting the two or more light sources to intersect at a point; and
displaying a 3D image that appears to the user to float in space.

15. The method of claim 14 further comprising guiding two or more light sources using one or more mirrors.

16. The method of claim 15 further comprising adjusting the one or more mirrors via an adjustment device.

17. The method of claim 14 wherein said projector does not comprise a drive module.

18. The method of claim 14 wherein said glasses comprise shutter glasses.

19. The method of claim 18 further comprising synchronizing the two or more light sources with the glasses via an electrical circuit.

20. The method of claim 14 wherein the glasses comprises passive glasses.
